(19) United States
(12) Patent Application Publication
(10) Pub. No.: US 2022/0190535 A1
(43) Pub. Date: Jun. 16, 2022

(54) PLUG CONNECTOR WITH INTEGRATED VOLTAGE SPLITTER

(71) Applicant: HIRSCHMANN AUTOMOTIVE GMBH, Rankweil/Brederis (AT)

(72) Inventor: Werner JAEGER, Rankweil/Brederis (AT)

(21) Appl. No.: 17/598,919

(22) PCT Filed: May 15, 2020
(86) PCT No.: PCT/EP2020/063691

§ 371 Date: Sep. 28, 2021

(30) Foreign Application Priority Data
May 16, 2019 (DE) 10 2019 112 890.0

(51) Int. Cl. H01R 31/08

(52) U.S. Cl. CPC H01R 31/08; H01R 2201/26

(57) ABSTRACT

The invention relates to a plug-in connection (100) having a plug-in connector (2) and a mating plug-in connector (3) that can be plugged into the latter, wherein the plug-in connector (2) has a housing (4) in which a plurality of contact partners are arranged that can be plugged into corresponding contact partners of the mating plug-in connector (3), characterised in that, in the housing (4) of the plug-in connector (2), a potential element (103) is arranged that at least forms a contact partner of the plug-in connector (2) for some of the corresponding contact partners of the mating plug-in connector (3).

The invention relates to a plug-in connection having a plug connector and a mating plug connector that can be plugged together therewith, where the plug connector has a housing in which a plurality of contacts are provided that can be plugged together with corresponding contacts of the mating plug connector, according to the features of the preamble of claim 1.

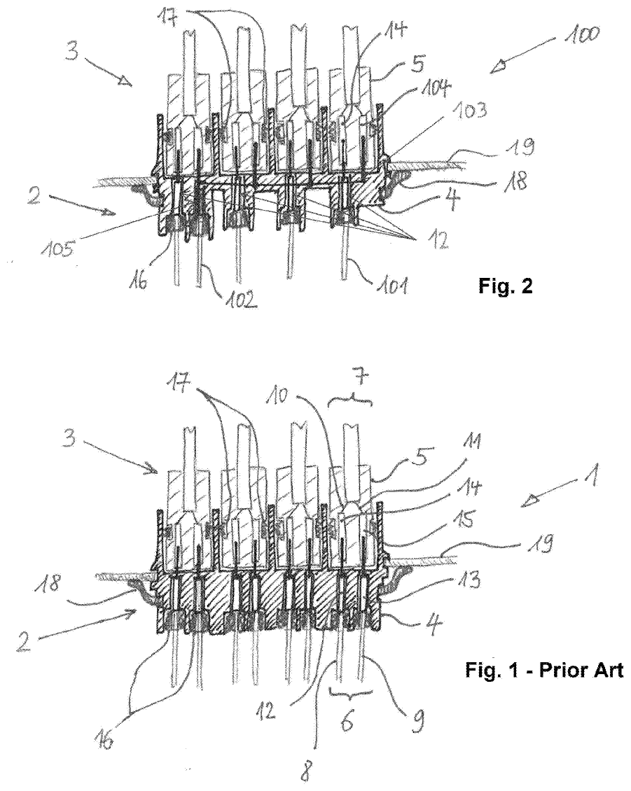

Such plug-in connections are known in principle. In this case a plug connector is provided that has a housing in which a plurality of contacts are provided. At the end of a line that has a plurality of electrical conductors, a contact is provided for each electrical conductor, for example soldered or crimped thereto. Each contact of the plug connector corresponds with a contact of the mating plug connector, so that the contacts corresponding with each other establish an electrical connection when the plug connector is plugged together with the mating plug connector to form the plug-in connection. This means that there must be a corresponding number of contacts in the plug connector and the corresponding mating plug connector, depending on the number of electrical conductors in the cable (or, if applicable, plurality of cables). This increases the variety of parts as well as the assembly effort. A known generic plug connector is shown in FIG. 1 and is described in more detail below in the description of the drawing.

The object of the invention is therefore to make a generic plug-in connection simpler in terms of the assembly effort and to reduce the variety of parts.

This object is achieved by the features of claim 1.

According to the invention, it is provided that a potential element is in the housing of the plug connector and forms at least contacts of the plug connector for a part of the corresponding contacts of the mating plug connector.

In other words, the invention thus relates to a plug-in connection in the form of a sectioning point with integrated ground-potential distributor. With this sealing sectioning point embodiment, the number of required contact parts, sealing elements, line material, material quantity of plastic and the like can be reduced for the design of a vehicle wiring harness. The embodiment can also be used with a non-sealing sectioning point. In addition, there is the advantage that the embodiment according to the invention does not change the installation space and thus provides backward compatibility with existing (sealed and non-sealed) embodiments. Therefore, not only future vehicle series or vehicle-specific solutions, but also existing systems in the sectioning point region can be covered without restrictions to the existing installation space or installation situations.

The variety of parts is reduced by the fact that the potential element is in the plug connector and thus a plurality of electrical conductors are combined in respect of their electrical potential (such as a ground connection). Therefore, the number of electrical conductors of the line at which the plug connector is closed can be reduced, since a single electrical conductor (such as a ground conductor) can be connected to the contacts of the mating plug connector via the potential element at a plurality of contacts formed by this potential element.

In further refinement of the invention, it is provided that the potential element forms a contact for each of exactly half the number of contacts of the mating plug connector. This makes it possible to achieve the greatest possible savings potential in respect of the variety of parts and also the assembly effort.

Alternatively, it does not have to be half; for example, it can be only the ground in the case of a three-pin plug-in connection. Plus and signal would be plugged directly, for example.

Furthermore, it would also be conceivable not to share the potential at all connectors in the sectioning point if, for example, a separate ground is necessary for EMC reasons.

In a refinement of the invention, it is provided that the potential element is in the form of a lead frame. This allows this potential element, and thus also the plug connector in which this element is provided, to be manufactured particularly quickly, easily and inexpensively. This applies above all if the housing is manufactured in a plastics injection-molding process, in which the lead frame is overmolded. As an alternative to overmolding, the housing and the lead frame can be manufactured as separate parts and then assembled together, for example, by inserting and fixing the lead frame in the housing, by means of latching, pressing, adhesively bonding or the like.

In a refinement of the invention, it is provided that the housing of the plug connector is made of plastic and the potential element is encased by the plastic except for each region forming a contact. This protects, in particular, the current-carrying regions of the plug connector from external influences and also from contact. However, the potential element does not necessarily have to be completely encased, if there are sufficient clearances with regard to voltages and creepage currents.

In a refinement of the invention, it is provided that the potential element has a separate contact that is not a contact of the mating plug connector. For example, the ground line is connected to the plug connector at this contact. At the same time, it is necessary that one of the contacts of the plug connector is contacted with a corresponding contact of the mating plug connector in order to transmit the ground via the plug-in connection. This means that the connector from which the ground is branched off (especially the one with the largest cross-section, for example as in an axle sectioning point) will still have a contact on the mating side.

Further embodiments of the plug-in connection according to the invention are described in the dependent claims, from which corresponding advantages result.

Of particular advantage is the application of the plug-in connection according to the invention in the field of motor vehicles. On the one hand, the plug connector with the potential element in it can be provided and fixed to a part of the vehicle, in particular a body panel. Once this has been done, the wiring harness is much easier to install because it contains fewer electrical conductors. This results not only in a cost saving but also in a weight saving.

In FIG. 1, a plug-in connection, as far as shown in detail, is indicated at reference numeral 1. This plug-in connection 1 is known as such and has a plug connector 2 and a mating plug connector 3 that can be plugged together therewith. The plug connector 2 has a housing 4. The mating plug connector 3 has a housing 5. Both the plug connector 2 and the mating plug connector 3 are each connected at the end of a line 6, 7. In FIG. 1, there are a total of four lines 6, 7 each, wherein the number may also be larger or smaller. Each line 6, 7 has an electrical conductor 8, 9 (in each case with sheathing) on the side of the plug connector 2 and electrical conductors 10, 11 (likewise in each case with sheathing) on the side of the mating plug connector 3. More than two electrical conductors per line can also be provided. A contact 12, 13 or 14, 15 is at the end of each electrical conductor 8, 9 or 10, 11 respectively. In the plugged-together state of plug connector 2 and mating plug connector 3 shown in FIG. 1, the various contacts 12, 13 of the plug connector 2 are plugged together with the various corresponding contacts 14, 15 of the mating plug connector 3. This means that there are as many contacts on each side of the plug-in connection 1 as there are electrical conductors 8, 9 or 10, 11 of one, two, or more than two lines 6, 7. According to FIG. 1, single conductor seals 16, 17 may still be present, but need not be, by means of which the electrical conductors 8, 9 or 10, 11, respectively, are sealed with respect to the housing 4 of the plug connector 2 or with respect to the housing 5 of the mating plug connector 3, respectively, in order to achieve longitudinal water-tightness. In addition, a housing seal 18 may, but likewise need not, be present. Such a housing seal 18 is required if the plug connector 2 is inserted with its housing 4 in an opening of a mounting base 19 and is fixed there. In FIG. 1, it can be seen that the housing 4 of the plug connector 2 extends through the opening of the mounting base 19 and forms a receiving space for the mating plug connector 3. In this case, the outer contour of the housing 4 of the plug connector 2 has latching tabs (partly or fully circumferential), by means of which the housing 4 of the plug connector 2 can be fixed to the mounting base 19. Other ways of fixing the housing 4 of the plug connector 2 to the mounting base 19 are also possible and are known in principle.

FIG. 2 shows, based on some identical parts of the plug-in connection 1 according to FIG. 1, a plug-in connection 100 according to the invention. In the case of this plug-in connection 100, a line 101 is present in each case that also has an electrical conductor, at the end of which a contact 12 is provided. This contact 12 of the plug connector 2 of the plug-in connection 100 also corresponds to a contact 14 of the mating plug connector 3. However, in contrast to the plug-in connection 1, there is no second electrical conductor 9 (see FIG. 1), and instead a potential element 103 is connected to a line 102 in the housing of the plug connector 2 of the plug-in connection 100. The potential element 103 thus saves the second electrical conductors (according to FIG. 1 the electrical conductors 8 and their associated contacts), so that the variety of parts is thereby reduced. Advantageously, it is only also necessary to connect the potential element 103 via the electrical line 102 so that the potential element 103 that forms the contacts for the associated contacts of the mating plug connector 3, can be plugged together with these contacts of the mating plug connector 3, so that the assembly effort is thereby reduced. In other words, this means that the potential element 103 can be used to save a number of contacts of the plug connector 2 and the corresponding lines therefor (and possibly other parts such as seals and so on), since these are combined via the potential element 103. The potential element 103 itself can either be electrically fixedly contacted with the electrical conductor of the line 102 (for example by soldering) or it also forms a contact that is plugged together with a contact connected to the end of the electrical conductor of the line 102. The other contacts of the plug connector 2 and the contacts 104 of the mating plug connector 3 remain unchanged, as shown in FIG. 1 and serve independently of each other for signal/or energy transmission, whereas the contacts 14 of the mating plug connector 3 that have been plugged together with the potential element 103, are all at the same potential (such as ground). The contact on the electrical conductor of the electrical line 102 and plugged together with the potential element 103 has the reference sign 105. The other elements of the plug-in connection 1 which are not directly associated with the potential element 103 (such as, in particular, the single conductor seals 16, 17, the housing seal 18 and the like) may also be present in the plug-in connection 100 according to the invention, but do not have to be.

The housing 4 of the plug connector 2 of the plug-in connection 100 can also be inserted in an opening of the mounting base 19 and preferably fixed there in a latching manner. It is of particular advantage if the mounting base 19 is a body panel of a vehicle, in particular in the region of an axle wiring (for speed sensors, ABS sensors, actuators for a damper adjustment and the like) or if the mounting base 19 is part of an add-on part, in particular a mirror, of a vehicle. This is because in these regions in particular there is not enough installation space available to lay a correspondingly thick wiring harness, and so here the reduction in the variety of parts, in particular the reduction of electrical lines, is of particular advantage. In addition, especially in the region of the axle wiring, there is the advantage of a weight saving if there are fewer electrical lines.

The insertion of the housing into a mounting base is not absolutely necessary. The plug-in connection described above in general or in the context of the exemplary embodiment can also be an interface that is located or integrated freely, for example in a cable duct.

### LIST OF REFERENCE SIGNS

1 Plug-in connection
2 Plug connector
3 Mating plug connector
4 Housing
5 Housing
6 Line
7 Line
8 Electrical conductor
9 Electrical conductor
10 Electrical conductor
11 Electrical conductor
12 Contact
13 Contact
14 Contact
15 Contact
16 Single conductor seal
17 Single conductor seal
18 Housing seal
19 Mounting base
100 Plug-in connection
101 Line
102 Line
103 Potential element
104 Contact
105 Contact

1. A plug-in connection comprising:
a main plug connector having a housing;
a mating plug connector that can be plugged together the main connector;
a plurality of main contacts in the housing;
respective mating contacts of the mating plug connector pluggable with the main contacts; and
a potential element in the housing of the main plug connector and forming at least the main contacts for at least some of the mating contacts of the mating plug connector.

2. The plug-in connection as according to claim 1, wherein the potential element forms exactly half the mating contacts of the mating plug connector.

3. The plug-in connection as according to claim 1, wherein the potential element is formed as a lead frame.

4. The plug-in connection as according to claim 1, wherein the housing of the main plug connector is formed of plastic and the potential element is encased by the plastic except for each region forming a contact.

5. The plug-in connection as according to claim 1, wherein the potential element has a separate contact that is not a contact of the mating plug connector.

6. The plug-in connection as according to claim 1, wherein the housing of the main plug connector is suitable and designed to be inserted and fixed in a recess of a mounting base.

7. The plug-in connection as according to claim 6, wherein the mounting base is a body panel of a vehicle.

8. The plug-in connection as according to claim 6, wherein the mounting base is a part of a mirror of a vehicle.
